(19) United States
(12) Patent Application Publication
(10) Pub. No.: US 2016/0074262 A1
(43) Pub. Date: Mar. 17, 2016

(54) Intelliwalker, an intelligent, sensor equipped, motorized robotic walking assistance device.

(71) Applicants: Sophia Vasiliki Moses, Arlington, VA (US); Jeffrey Tolbert, Centreville, VA (US); Michael Angello Machado, Manassas Park, VA (US); Nicholas S. Blasey, Kensington, MD (US); Julia L. Dunbar, Fairfax, VA (US); Megha Luthra, McLean, VA (US); Rohit Madhu, Fairfax, VA (US)

(72) Inventors: Sophia Vasiliki Moses, Arlington, VA (US); Jeffrey Tolbert, Centreville, VA (US); Michael Angello Machado, Manassas Park, VA (US); Nicholas S. Blasey, Kensington, MD (US); Julia L. Dunbar, Fairfax, VA (US); Megha Luthra, McLean, VA (US); Rohit Madhu, Fairfax, VA (US)

(21) Appl. No.: 14/846,815

(22) Filed: Sep. 6, 2015

Related U.S. Application Data
(60) Provisional application No. 62/097,020, filed on Dec. 26, 2014.

(51) Int. Cl. A61G 5/04; A61G 5/06; A61G 5/08; H04W 88/02

(52) U.S. Cl. CPC A61G 5/047; H04W 88/02; A61G 5/066; A61G 5/08; A61G 2005/1089

(57) ABSTRACT

An intelligent, self-propelled assistive walking and cargo-carrying device that utilizes various sensors to monitor the intended movement and balance of its pedestrian user and the device in relation to the surrounding terrain to ensure stability, provides the capability to ascend or descend stairs and uneven terrain via removable motorized treads, and can enhance the pedestrian user's ability to comprehend and interact with the environment through hearing amplification, range-finding, and interaction with personally-worn smart devices (e.g., smart phones, smart watches, smart bands, etc.). The embodiment can be controlled by the user through pressure-sensitive grips and controls, voice, detected motion of the user, or remotely through wireless connection. The embodiment can be programmed to be user-specific and to follow a pre-determined path or to arrive at a target location.

### CROSS-REFERENCE TO RELATED APPLICATIONS

This application claims the benefit of provisional patent application Ser. No. 62/097,020, filed 2014 Dec. 26 by the present inventor, which is hereby incorporated by reference in its entireties into this application.

### GOVERNMENT SUPPORT STATEMENT

This invention was not made at a U.S. Government research facility. Ms. Moses, and her co-inventors, developed this invention while server as volunteer researchers during the Aspiring Scientist Summer Internship Program. Ms. Moses, and her co-inventors, retains all commercial interests herewith.

### BACKGROUND

### Prior Art

The following is a tabulation of some prior art that presently appears relevant:

### U.S. Patents

| Patent Number | Issue Date | Patentee |
|---|---|---|
| 9,062,986 | 2015 Jun. 23 | Ellis |
| 8,752,658 | 2014 Jun. 17 | Kurek |
| 8,627,909 | 2014 Jan. 14 | Chang et al |
| 8,172,023 | 2012 May 8 | Irvine |
| 8,127,875 | 2012 Mar. 6 | Mattes et al |
| 7,793,950 | 2010 Sep. 14 | Van Eeden |
| 7,540,342 | 2009 Jun. 2 | Ein |
| 6,983,813 | 2006 Jan. 10 | Wright |
| 6,842,692 | 2005 Jan. 11 | Fehr et al |
| 6,378,883 | 2002 Apr. 30 | Epstein |
| 5,526,893 | 1996 Jun. 18 | Higer |
| 5,411,044 | 1995 May 2 | Andolfi |
| 5,168,947 | 1992 Dec. 8 | Rodenborn |
| 5,137,102 | 1992 Aug. 11 | Houston, Sr. |
| 4,809,804 | 1989 Mar. 7 | Houston |
| 4,802,542 | 1989 Feb. 7 | Houston |
| 4,768,536 | 1988 Sep. 6 | Hawkins |
| 4,280,578 | 1981 Jul. 28 | Perkins |
| 3,872,945 | 2012 Mar. 6 | Hickman et al |

### BRIEF SUMMARY

### Background of the Invention

1. Field of the Invention

This invention relates in general to wheeled walking aids for disabled persons (CPC A61H 3/04). In one embodiment, the invention relates to assisting pedestrians traverse a variety of surfaces, including inclines, stairs, and uneven terrain. In another embodiment, the invention can sense and monitor the environment and the device's user, such as enhancing user's hearing, detecting, and preventing, potential falls by the user through advanced sensors, telecommunications and computer processing. In a third embodiment, the invention can assist pedestrians to carry loads or even carry a pedestrian over a variety of surfaces through advanced sensors, telecommunications and computer processing.

2. Background Art

As the United States population ages, there is a critical need for new technologies that assist walking, climbing stairs, traversing inclined surfaces, and carrying items. In 2013, four million people Americans were over the age of 65. The size of America's elderly population continues to grow. In addition, the number of Americans who need assistance to walk, such as those afflicted with disease or injuries, continues to increase. Today, the elderly and infirm can use a variety of portable walkers. However, walkers currently on the market are difficult to use walking uphill or downhill or even impair a pedestrian's ability to traverse such terrain. Also, such walkers do not monitor the pedestrian's balance and can do little to help the pedestrian avoid dangerous falls.

Prior Art relies on a variety of modalities to assist users with injuries or disabilities to walk or travel. These modalities can be classified into two broad categories, walkers with semi-enclosed frames and wheeled platforms or wheelchairs. Both of these categories of prior art include free-wheeling and power-assisted designs.

Prior art that offer free-wheeling and power-assisted or self-propelled designs often employ retractable motorized drive trains or motorized wheels. As a result, walkers, wheeled platforms or wheelchairs with retractable drive trains or wheels are often heavy which impairs the device's maneuverability and stability. Further, such retractable designs are impractical for traversing uneven surfaces, particularly stairways and inclines, which limits their effectiveness.

Prior art do not provide a practical means to assist users traversing uneven surfaces or ascending or descending inclines, such as stairways. For example, a prior art device designed to assist users to ascend of descend stairs accomplishes this by raising and lowering the walker's front and back legs via an actuator to ensure an upright vertical position of the walker. When a user pushes or rolls the walker to the base of a stairway, the walker is difficult to move since it must be lifted above each stair step, which is impractical for a user who needs a walker to lean on to walk in the first place. Further, a user can fall backwards when lifting a walker while attempting to ascend each step. When a user decides to descend a stairway, the user pushes or rolls the walker to the top of the stairway and then pushes the walker beyond the first step until it falls to the next step below. This quickly becomes a precarious and unstable position for the user since the user can easily lose balance and fall forward over the walker and down the stairs.

Recently, a few power-assisted walkers, wheeled platforms or wheelchairs have employed select sensors or computer processing units to assist in navigation, obstacle identification and avoidance. Such capabilities do very little to assist a user who is losing balance or who cannot keep pace with a self-propelled device. Prior art fails to sense the user's stability in relation to the device and nearby terrain. Further, prior art is insufficient in dynamically adjusting itself to increase its user's stability to prevent falls.

Virtually no prior art uses a combination of advanced sensing capabilities, computer processing, and wireless communications to supplement users ability to sense the environment and interact with it.

While some walkers offer the ability to convert to a wheeled platform or wheelchair, few, if any, offer the ability to carry cargo. Further, virtually no prior art uses a combination of advanced sensing capabilities, computer processing, and wireless communications to supplement users' ability to sense the environment and interact with it.

### BRIEF SUMMARY OF THE INVENTION

The Intelliwalker was invented to assist individuals, who are having difficulty walking, maintain their mobility by providing a computerized, powered, and user-controlled walker through advanced sensing, stability control, communications, and user-centric interface design. This invention is a self-propelled, robotic walker connected to advanced sensors that aids the elderly or those needing assistance and can detect if the user is losing balance, the walker is moving too fast, can provide sensory clues to the user about the environment and performance of the walker, can adapt to different surfaces (flat, inclined, uneven), and can be operated in a semi-autonomous modality.

The Intelliwalker incorporates motorized wheels and a removable tread (a.k.a., track) interface to assist users traverse flat, uneven, or inclined surfaces. The invention can travel forward or backward and climb stairs. The invention includes sensors (e.g., laser, Global Positioning System, accelerometer, tactile pressure detector, ultrasonic, microphone, tilt) that can track the user's position in relation to the Intelliwalker, the force and direction of pressure the user places on Intelliwalker, the relative position of the Intelliwalker from a vertical position, and the speed the Intelliwalker is traveling. The invention also includes sound sensors to enhance the user's hearing.

The Intelliwalker is compatible with sensors built in shoes, wristbands, watches, and smartphones or other devices using wireless data transmission (e.g., Bluetooth, IEEE 802.11, RFID) to track a user's movement, pace, balance, and direction, and can be used to calibrate the walker to better assist the user. For instance, the Intelliwalker can integrate with sensors built in shoes to track a person's steps and pace and use this information to calibrate the invention to better assist the user. Most importantly, the Intelliwalker also can detect the relative balance of its user through pressure sensors in the user's shoes and compare the data to the Intelliwalker's pressure data to regulate its actions (e.g., modify its center of gravity, accelerate or decelerate, or shut down) based on the feedback from its onboard sensors and sensors worn by users.

Finally, the Intelliwalker can be programmed and enhanced for other purposes, such as carrying items, carrying people, and being remotely operated.

### ADVANTAGES

Accordingly, several advantages of one or more aspects of the Intelliwalker are as follows:
Adaptive propulsion
   Intelliwalker can move using wheels or removable lightweight treads,
   Intelliwalker can be pushed by the user or be self-propelled via electric motors at the user's command.
   Intelliwalker can traverse flat surfaces, inclines and declines including stairs, and uneven terrain.
Dynamic stability
   Intelliwalker actively monitors the user's position and its position relative to the user and to nearby terrain via advanced sensors (including but not limited to accelerometers, gyroscopes, lasers, GPS, and ultrasonic) connected to an onboard computer and wireless communication devices.
   Intelliwalker can adapt its propulsion, such as slowing, stopping, or changing direction, when it senses the user is unstable and may fall or is unable to keep up with the Intelliwalker.
   Intelliwalker can adapt its relative center of gravity, such as shortening or lengthening telescopic legs, when it senses the user is unstable and may fall or to adjust to its environment.
User-centric interface design
   Intelliwalker can receive and transmit information from the user and the environment through a variety of sensors (including but not limited pressure-sensitive grips, microphones, lasers, accelerometers, GPS, wireless communication transceivers, ultrasonic, and other modalities) and interfaces (including but not limited to photon emitting displays such as LED screens or lights, sound speakers, vibration servos, and thermal circuits) and processed through an on board computer and wireless communication devices.
   Intelliwalker can receive and transmit information about itself to the user through a variety of sensors and interfaces, including but not limited to those listed above, and processed through an on board computer and wireless communication devices.
Convertibility
   Intelliwalker can be adjusted by the user to ensure proper fit, including but not limited to height and hand size.
   Intelliwalker can be easily converted from an upright user-pushed walker to a self-propelled user-controlled robotic walker.
   Intelliwalker can be converted from an upright walker to a walker with a seat (for supporting the user or cargo).
   Intelliwalker can be enhanced through software upgrades and hardware add-ons.

### DETAILED DESCRIPTION

### Description of the Invention

While this invention can be embodied in many different forms, the following descriptions herein are specific embodiments. The present disclosure is to be considered as an exemplification of the principle of the invention intended merely to explain and illustrate the invention, and is not intended to limit the invention in any way to embodiments illustrated.

Movement and Self-Propulsion:
The Intelliwalker is an embodiment based on enhancements to wheeled walking aids for disabled persons (CPC A61H 3/04). The embodiment incorporates a computer, traction motor, wireless communication devices, and advanced sensors and user-interfaces to enable users to move forward at a pace they determine. It is designed with removable treads to allow for easy mobility over various terrains. Removable treads enables the embodiment to travel over sticks, wires and other small obstacles. The Intelliwalker can climb stairs, assisting those needing help as well as moving itself so that it doesn't need to be carried. The device also can move backwards. The device's gears are designed in a ratio of 1:9 and can withstand more than 190 pounds on each side of the device.

Relative Position Detection:
The Intelliwalker employs a number of sensor systems to monitor the user's position in relation to the device, to local surroundings, to the earth and the relative speed of the device. For example, the Intelliwalker uses lasers and ultrasonic sensors to track the user's position in relation to the walker and to detect nearby obstacles. The lasers and ultrasonic sensors monitor the distance the user is from the device and if the device is moving too quickly for the user. The lasers and ultrasonic sensors also can detect environmental obstacles and can either notify the user of these hazards or automatically stop the Intelliwalker or redirect its direction of movement to avoid the hazard. If the user is more than two feet from the device, it will stop moving (unless it is operating remotely or in carrying mode). The Intelliwalker also employs GPS to indicate the device's global position, direction, and rate of movement.

Speed and Balance:
The device's speed can be programmed and calibrated to fit the user's desired speed using the LCD display. The Intelliwalker also uses an accelerometer to sense the speed of the device and the user. It also uses an accelerometer to sense the angle at which the walker is positioned so that if the user is falling, the device will catch itself so that the user does not need to pick it up. Combining the accelerometer and ultrasonic detectors enables the Intelliwalker to navigate through uneven terrain by instantaneously calculating the device's center of balance in relation to its speed and nearby terrain.
The Intelliwalker also can detect the relative balance (e.g., yaw, pitch, roll) of the device and the relative balance of its user through pressure sensors in user's shoes or on the user and regulate its actions based on the feedback from its onboard sensors and sensors worn by users. For instance, if the Intelliwalker detects a pressure differential exceeding a pre-determined limit which is a precursor to tilting over and losing balance, the Intelliwalker will notify the user through sound, display, and or vibration and or modify its operation to seek balance (e.g., modify its center of gravity through adjusting internal weights, accelerate or decelerate absolute or differential speed, or shut down). In addition, the Intelliwalker will send and receive data from sensors in user's shoes (or other user worn devices) that detect the weight and pressure on the soles of the feet. These data will communicate information regarding whether a user is exceeding a pre-determined limit which is a precursor to losing balance and notify the user through sound, display, and or vibration and or modify its operation to seek balance. These pressure sensors are designed to detect tilt and ensure balance thereby providing a safety feedback loop.

Pressure Sensing Feedback:
The Intelliwalker employs pressure sensors to detect the direction and speed the user wishes to move. The device's handles have pressure sensors that are programmed to move the wheels only when certain pressures are applied to them. The degree of pressure can be adjusted by the user. Depending on the user's grip on the handles, the walker will change speed to adjust to the user's response. For instance, as a user tightens his or her grip the Intelliwalker will accelerate. In contrast, if the user abruptly presses hard on the handles, the walker will stop to allow the user to stop or to regain his or her balance. The Intelliwalker also will stop if no pressure is applied, unless the Intelliwalker is switched to remotely-operated carrying mode.
In addition, the Intelliwalker senses and moves according to the user's intended motion by detecting differential pressure they are exerting on the handles. For instance, if the user grips the right-handle more tightly than the left, then the right-hand wheels will increase in speed compared to the left and begin turning the device to the left.

Remote Operation and Connectivity:
The Intelliwalker can be operated by a remote user, once the device is switched to that mode and connected by a compatible wireless device. Operating the Intelliwalker remotely enables a user to move it to a different location for another user or use (e.g. for repairs) or to remotely carry a person unable to walk themselves or to carry a load. In addition, the device can be programmed with specific instructions or be upgraded either wirelessly or through a direct connection (e.g., connected to a SD card or USB device). The Intelliwalker can connect to other devices via Bluetooth and RFID, exchanging data and user instructions. For instance, user's wearing shoes, wristbands, or phones can receive and store information about their travels, including pace, direction, and duration.

Audible Sound Enhancement:
The Intelliwalker uses sound sensors to detect sounds to enhance the user's hearing. Sound sensors or microphones will be positioned at different points at the walker and will filter surrounding noises, selecting which sounds to amplify to the user. This would serve to enhance the user's hearing aid. Sensors built in shoes, such as Nike shoes, would track the user's motion and how they walk. Sensors in the user's shoes will track the user's walking patterns and the device will be able to be calibrated to the user.

Components
The Intelliwalker is comprised of a u-shaped, semi-enclosed, sturdy, rigid frame (e.g., metal, advanced composites), electrical wiring, re-chargeable battery, roll able and free-wheeling motorized driving wheels (e.g., in-wheel hub motors), removable tread assemblies (also known as treads), electric servos and actuators, hydraulics, pneumatic system, computer and data memory device, wireless transmitters/receivers, LED and LCD displays, audio speakers, microphones, rubberized grips, and sensors (accelerometer; gyroscope; Global Positioning System; laser; pressure, radar, sonar; tactile pressure; tilt, thermometer, ultrasonic) that monitor the position and direction of the device and the user, and features of the nearby terrain.

The foregoing description merely explains and illustrates the invention and the invention is not limited thereto, inasmuch as those skilled in the art, having the present disclosure before them will be able to make modifications and variations therein without departing from the scope of the invention.

General Claims:

What is claimed is:

1. An intelligent self-propelled, walking-assistant device (e.g., walker, wheelchair) that can be operated by a pedestrian user for guiding said user through an environment with uneven terrain (e.g., inclines, declines, stairways) comprising: a) two removable motorized treads, a.k.a., tracks (or wheels) which can be affixed to the front and rear wheel assemblies on each side of the device; b) user can operate said motorized treads (or wheels) in variable speeds and in forward and reverse directions in order to turn the walker; c) multiple sensing systems (e.g., accelerometer, gyroscope, Global Positioning System, laser, pressure, radar, sonar, thermometer, ultrasonic) to monitor the position, speed, direction (e.g., differential speed of treads or wheels), and balance (e.g., yaw, pitch, roll) of the device, the device in relation to its user and/or load, and surrounding environment to assist the user and/or load to move across flat, uneven, or inclined surfaces and automatically adjust speed and itself to ensure an upright position; d) a communication and processing system that can transmit and regulate the device's actions based on the feedback from onboard sensors and sensors worn by the user as well as transmit operating data; e) a u-shaped frame that wraps around its user and supported by four cross-braced vertical posts ending in said motorized treads (or wheels) connected in the front and having handles on an upper portion of the frame suitable to be gripped by a user; f) said u-shaped frame with a moveable seat that can fold-down and is suitable to support a 225 pound adult; g) said cross-braced vertical posts ending in said motorized treads (or wheels) can be lengthened or shortened by various means (e.g., hydraulic fluids, screw drives, gears, magnets, actuators) to adjust the walker when traversing inclines, declines, stairs or uneven terrain to ensure user stability; and h) visual displays (e.g., lights, LCD screens, LED screens), audio speakers (e.g., sounds, voice), and tactile displays (e.g., vibration, heat, cold) that can indicate conditions about the local environment, user conditions, information transmitted through wireless communication, and said device's operating conditions.

2. Said intelligent self-propelled, walking-assistant device (e.g., walker, wheelchair) can be operated by remote control to guide said pedestrian user or cargo through an environment with uneven terrain (e.g., inclines, declines, stairways) comprising: a) two removable motorized treads, a.k.a., tracks (or wheels) which can be affixed to the front and rear wheel assemblies on each side of the device; b) user can operate said motorized treads (or wheels) in variable speeds and in forward and reverse directions in order to turn the walker; c) multiple sensing systems (e.g., accelerometer, gyroscope, Global Positioning System, laser, pressure, radar, sonar, thermometer, ultrasonic, tactile pressure) to monitor the position, speed, direction (e.g., differential speed of treads or wheels), and balance (e.g., yaw, pitch, roll) of the device, the device in relation to its user and/or load, and surrounding environment to assist the user and/or load to move across flat, uneven, or inclined surfaces and automatically adjust speed and itself to ensure an upright position; d) a communication and processing system that can transmit and regulate the device's actions based on the feedback from onboard sensors and sensors worn by the user as well as transmit operating data; e) a u-shaped frame that wraps around its user and supported by four cross-braced vertical posts ending in said motorized treads (or wheels) connected in the front and having handles on an upper portion of the frame suitable to be gripped by a user; f) said u-shaped frame with a moveable seat that can fold-down and is suitable to support a 225 pound adult; g) said cross-braced vertical posts ending in said motorized treads (or wheels) can be lengthened or shortened by various means (e.g., hydraulic fluids, screwdrivers, gears, magnets, actuators) to adjust the walker when traversing inclines, declines, stairs or uneven terrain to ensure user stability; and h) visual displays (e.g., lights, LCD screens, LED screens), audio speakers (e.g., sounds, voice), and tactile displays (e.g., vibration, heat, cold) that can indicate conditions about the local environment, user conditions, information transmitted through wireless communication, and said device's operating conditions.
Specific claims: The Intelliwalker can:

1. assist said user to safely walk, run, or traverse on flat, uneven, or inclined surfaces or climb up and down stairs by . . .
1.1. enabling said user to adjust the four vertical posts ending in two removable motorized treads (or four motorized wheels) to an appropriate, pre-defined positional parameters or to user-defined lengths and to reset said vertical posts to a level position;
1.2. enabling said user to adjust the speed and direction (e.g., forward, reverse) of said motorized treads (or said motorized wheels) to allow said device to turn clockwise or counter-clockwise and to reset said treads (or said wheels) to the same speed and to reset said treads (or said wheels) to the same direction to move forward or reverse;
1.3. automatically detecting the position of the device and direction of movement in relation to the incline of the terrain to dynamically ensure that it is operating in an appropriate, pre-defined and adjustable positional parameters;
1.4. automatically detecting and adjusting the device's speed and direction of movement if it is outside pre-defined and adjustable parameters to ensure it is travelling at an appropriate speed;
1.5. automatically detecting if a person or load being carried is falling and adjust its speed and/or direction of movement and/or shut itself off to revert to a more stable position;
1.6. propelling itself, as directed by a user, on flat, uneven, or inclined surfaces or stairs;
1.7. maintaining its position to optimize the stability of a user standing, walking or running;
1.8. indicating local environmental conditions (e.g., slope, potential obstacles, temperature, humidity, ground friction), conditions about user (e.g., stability, pace, on-person smart devices), conditions transmitted through wireless communication, and said device's operating conditions (e.g., speed, direction, level of tilt) via visual displays (e.g., lights, LCD screens, LED screens), audio speakers (e.g., sounds, voice), and tactile displays (e.g., vibration, heat, cold).

2. assist said user to carry or convey another person or a load on flat, uneven, or inclined surfaces or up and down stairs by
2.1. enabling said user to adjust the four vertical posts ending in two removable motorized treads (or four motorized wheels) to an appropriate, pre-defined positional parameters or to user-defined lengths and to reset said vertical posts to a level position;
2.2. enabling said user to adjust the speed and direction (e.g., forward, reverse) of said motorized treads (or said motorized wheels) to allow said device to turn clockwise or counter-clockwise and to reset said treads (or said wheels) to the same speed and to reset said treads (or said wheels) to the same direction to move forward or reverse;
2.3. automatically detecting the position of the device and direction of movement in relation to the incline of the terrain to dynamically ensure that it is operating in an appropriate, pre-defined and adjustable positional parameters;
2.4. automatically detecting and adjusting the device's speed and direction of movement if it is outside pre-defined and adjustable parameters to ensure it is travelling at an appropriate speed;
2.5. automatically detecting if a person or load being carried is falling and adjust its speed and/or direction of movement and/or shut itself off to revert to a more stable position;
2.6. propelling itself, as directed by a user, on flat, uneven, or inclined surfaces or stairs;
2.7. automatically maintaining its position to optimize the stability of a load in an immobile position or in movement;
2.8. indicating local environmental conditions (e.g., slope, potential obstacles, temperature, humidity, ground friction), conditions about user (e.g., stability, pace, on-person smart devices), conditions transmitted through wireless communication, and said device's operating conditions (e.g., speed, direction, level of tilt) via visual displays (e.g., lights, LCD screens, LED screens), audio speakers (e.g., sounds, voice), and tactile displays (e.g., vibration, heat, cold).

3. detect ambient sounds to assist said direct user or said remote user in hearing the immediate surroundings and transmit such information via sound, vibration, lights, or heat displays;

4. detect environmental conditions via sensors (e.g., accelerometer, Global Positioning System, gyroscope, laser, pressure, radar, sonar, ultrasonic) and wireless transmissions to assist said user or said remote user to navigate the immediate surroundings and transmit such information via sound, vibration, lights, or heat displays;

5. interact with current and future smart devices (e.g., smart wrist bands, smart watches, shoes, smart phones, clothing smart devices, etc.) to transmit, monitor, display and store speed, direction, pressure, balance (e.g. yaw, pitch, roll), distance, duration, and other parameters (e.g. calories burned) as well as use such data to self-calibrate to optimize said Intelliwalker for optimal performance (e.g., balance, speed) and a specific user(s), mission, or environmental condition to and regulate its actions based on the feedback from its onboard sensors and sensors worn by users;
6. be operated directly by a user or by remote control through wireless transmission (e.g., smart phone connected via Bluetooth, IEEE 802.11, or other local wireless protocol; wireless radio transmission);
7. be programmed and/or learn the habits, trends, or specific instructions of a given user, routed to a target location, follow a pre-determined path or mission, and/or accommodate a specific or dynamic environmental condition through wireless transmission or direct connection;

8. update and enhance its computer and software operating system for new purposes via wireless transmission (e.g., Bluetooth, IEEE 802.11, cellular radio) or direct connection (e.g., Universal Serial Bus, Secure Digital);
